(19) United States
(12) Patent Application Publication
(10) Pub. No.: US 2025/0307663 A1
(43) Pub. Date: Oct. 2, 2025

(54) METHOD AND SYSTEM FOR GENERATING KNOWLEDGE GRAPH

(71) Applicant: Panasonic Intellectual Property Management Co., Ltd., Osaka (JP)

(72) Inventors: Sahim YAMAURA, Singapore (SG); Debdeep Paul, Singpore (SG); Koji Miura, Osaka (JP)

(21) Appl. No.: 18/617,371

(22) Filed: Mar. 26, 2024

(51) Int. Cl. G06N 5/022; G06N 5/01

(52) U.S. Cl. CPC G06N 5/022; G06N 5/01

(57) ABSTRACT

The present disclosure relates to a method for generating a knowledge graph. The method includes determining a causal chain of events indicating a cause-and-effect relationship among entities within the input data based on a causal expression. Further, the method includes assigning attribute labels such as a topic label, a sentiment label, and a temporal label to the entities using a Natural Language Processing (NLP) technique. Further, the method includes creating nodes indicating a collection of entities having the assigned attribute labels. Furthermore, the method includes generating a knowledge graph based on clustering the nodes. The knowledge graph indicates a visual depiction of the causal chain of events such that the nodes are interlinked through a directional edge representing the causal chain of events. In the method, the generated knowledge graph along with the assigned attribute labels is retrieved based on at least one of a user-query input or parameter filters.

### FIELD OF THE INVENTION

The present disclosure relates generally to knowledge graphs, and more specifically, to a method and a system for generating knowledge graphs.

### BACKGROUND

In recent years, the field of knowledge mining from textual data has undergone remarkable technological advancements, revolutionizing the way users extract insights and understand complex relationships. One pivotal tool in this domain is a causal knowledge graph, which being a powerful data structure offers a structured representation of cause-and-effect relationships among entities that can serve as a powerful tool for explaining any downstream decision support system. However, despite these advancements, current techniques still face significant limitations in providing comprehensive mining of knowledge graphs based on attribute labels such as topic, sentiment, and temporal labels. This gap in functionality restricts the user's ability to search based on attributes (tags) and hampers the visualization of entity trajectories through unidirectional branches in the knowledge graph.

Causal knowledge graphs have emerged as a powerful tool for uncovering hidden relationships and understanding the dynamics of complex systems. By representing causal chains of events among entities, the knowledge graphs may offer invaluable insights into the underlying mechanisms driving observed phenomena. However, to fully harness the potential of the knowledge graphs, it may be essential to integrate attribute labels such as topic, sentiment, and temporal information into the mining process.

Topic labelling allows for the categorization of entities based on their subject matter, enabling users to explore specific themes or areas of interest within the knowledge graph. Sentiment analysis adds another layer of understanding by capturing the emotional tone or sentiment associated with entities, facilitating the identification of positive, negative, or neutral sentiments. Temporal labelling provides crucial context by indicating the time-related aspects of events, allowing users to analyze the evolution of relationships over time.

Despite the importance of attribute labels in enriching the insights derived from the knowledge graphs, current techniques often fall short in their ability to incorporate and utilize such labels effectively. This limitation impedes users' ability to perform targeted searches based on specific attributes and hinders the exploration of entity trajectories through the knowledge graph.

Furthermore, the lack of support for unidirectional branches in the knowledge graph poses another challenge. Unidirectional branches represent the directional flow of causality between entities, providing a clear trajectory of influence from cause to effect. However, existing techniques often fail to capture and visualize these unidirectional relationships, resulting in a fragmented view of the causal chain.

To address these challenges and unlock the full potential of causal knowledge graphs, innovative approaches are needed.

In conclusion, while the field of knowledge mining from textual data has witnessed significant advancements, there remain important challenges to overcome. Further, this also contributes towards the explainability of certain decision support systems to enhance the adoption of blackbox AI/ML systems through auxiliary and associated textual data. Leveraging the causal knowledge graphs offers immense potential for uncovering hidden relationships and understanding complex systems. However, addressing limitations in mining techniques to incorporate attribute labels and visualizing unidirectional branches is essential for realizing the full benefits of these powerful tools.

Therefore, there is a need for a solution to address the aforementioned issues and challenges.

### SUMMARY

This summary is provided to introduce a selection of concepts, in a simplified format, that are further described in the detailed description of the invention. This summary is neither intended to identify essential inventive concepts of the invention nor is it intended for determining the scope of the invention.

According to an embodiment of the present disclosure, a method for generating a knowledge graph is disclosed. The method includes determining a causal chain of events corresponding to an input data based on a causal expression, wherein the causal chain of events indicates a cause-and-effect relationship among one or more entities within the input data. Further, the method includes assigning one or more attribute labels to the one or more entities within the input data using a Natural Language Processing (NLP) technique, wherein the one or more attributes indicate a topic label, a sentiment label, and a temporal label. Further, the method includes creating a plurality of nodes based on the causal chain of events and the assigned one or more attribute labels, wherein each of the plurality of nodes indicates a collection of one or more entities having the assigned one or more attribute labels. Furthermore, the method includes generating a knowledge graph based on clustering the plurality of nodes, wherein the knowledge graph indicates a visual depiction of the causal chain of events among the one or more entities such that each of the plurality of nodes is interlinked through at least one directional edge representing the causal chain of events. In an aspect of the invention, the causal knowledge graph obtained from a textual dataset often becomes sparse and are thus pose challenges to draw inferences. To mitigate this, the present invention offers a simple but effective solution to cluster the arguments based on semantics to reduce the number of nodes to improve interpretability. In the method, the generated knowledge graph along with the assigned one or more attribute labels is retrieved based on at least one of a user-query input or parameter filters.

According to an embodiment of the present disclosure, a system for generating a knowledge graph is disclosed. The system includes a memory and at least one processor in communication with the memory. The at least one processor is configured to determine a causal chain of events corresponding to an input data based on a causal expression, wherein the causal chain of events indicates a cause-and-effect relationship among one or more entities within the input data. Further, the at least one processor is configured to assign one or more attribute labels to the one or more entities within the input data using a Natural Language Processing (NLP) technique, wherein the one or more attributes indicate a topic label, a sentiment label, and a temporal label. Further, the at least one processor is configured to create a plurality of nodes based on the causal chain of events and the assigned one or more attribute labels, wherein each of the plurality of nodes indicates a collection of one or more entities having the assigned one or more attribute labels. Furthermore, the at least one processor is configured to generate a knowledge graph based on clustering the plurality of nodes, wherein the knowledge graph provides a visual depiction of the causal chain of events among the one or more entities such that each of the plurality of nodes is interlinked through at least one directional edge representing the causal chain of events. Furthermore, the at least one processor is configured to retrieve the generated knowledge graph along with the assigned one or more attribute labels based on at least one of a user-query input or parameter filters, offering richer insights on the related factors.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an environment comprising a system for generating a knowledge graph, according to an embodiment of the present disclosure;

FIG. 2 illustrates a schematic block diagram of components of the system for generating the knowledge graph, according to an embodiment of the present invention;

FIG. 3 illustrates an exemplary process flow of a determining module of the system, according to an embodiment of the present invention;

FIG. 4 illustrates an exemplary process flow of an assigning module of the system, according to an embodiment of the present invention;

FIG. 5a illustrates an exemplary process flow of a generating module of the system, according to an embodiment of the present invention;

FIG. 5b illustrates an exemplary use-case depicting nodes created by the generating module of the system, according to an embodiment of the present invention;

FIG. 5c illustrates an exemplary use-case depicting clustering of the nodes by the generating module of the system, according to an embodiment of the present invention;

FIG. 6 illustrates an exemplary use-case depicting the knowledge graph using the system, according to an embodiment of the present invention; and

FIG. 7 illustrates a flowchart depicting a method for generating the knowledge graph using the system, according to an embodiment of the present invention.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

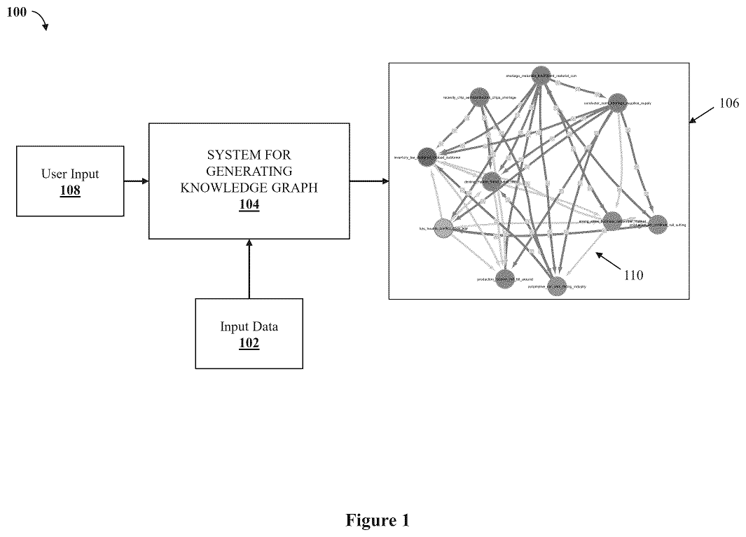

FIG. 1 illustrates an environment 100 comprising a system 104 for generating a knowledge graph 110, according to an embodiment of the present disclosure.

The environment 100 may further comprise an input data 102 and an output device 106 communicatively coupled to the system 104. The system 104 may be configured to generate the knowledge graph 106, additionally, the system 104 may be configured to receive a user input 108 indicating an ability for users to make queries and retrieve the knowledge graph 110 with attribute labels such as topic, sentiment, and temporal information, crucial for enhancing the usability and utility of the system 104 for knowledge mining. The input data 102 may correspond to a wide array of sources and formats, reflecting the diverse nature of information available for analysis. The input data 102 may include forecasts, offering insights into anticipated future events or trends, thereby aiding in proactive decision-making. Additionally, the system 104 processes the input data 102 related to news articles associated with specific domains, providing current and contextual information relevant to the user's field of interest. Further, the input data 102 may also include user-input text articles contributing valuable insights from diverse perspectives, enriching the pool of available knowledge (the input data). Moreover, the input data 102 may include predictions pre-stored in the system's 104 memory, and may serve as historical data points, allowing for comparative analysis and trend identification. Furthermore, the input data 102 may include a set of keywords empowering the users to tailor queries, enabling targeted exploration of specific topics or themes in the knowledge graph 110. This comprehensive approach to the input data 102 ensures that the system 104 to mine knowledge leverages a rich and varied dataset, facilitating robust analysis and informed decision-making across domains. The system 104 may be integrated within a server, a personal computing device, a user equipment, a laptop, a tablet, a mobile communication device, and so forth.

In an embodiment, the system 104 may correspond to a stand-alone system provided on an electronic device. The electronic device may include a personal computing device, a user equipment, a laptop, a tablet, a mobile communication device, or any other device capable of hosting processing and memory units. In an embodiment, the knowledge graph 110 may be generated on the output device 106 communicatively coupled to the system 104 or may be integrated with the electronic device hosting the system 104. In an alternate embodiment, the output device 106 may be a separate device from the electronic device hosting the system 104.

In another embodiment, the system 104 may be based in a server/cloud architecture and the system 104 may be communicably coupled to the output device 106 via a network (not shown). The network may be a communication network, a wireless network, a wired network, and the like. In another embodiment, the system 104 may be provided in a distributed manner, in that, one or more components of the system 104 may be provided, one or more components and/or functionalities of the system 104 are provided through an electronic device, and one or more components and/or functionalities of the system 104 are provided through a cloud-based unit, such as, a cloud storage or a cloud-based server.

In non-limiting examples, the output device 106 providing or displaying the knowledge graph 110 may include, but is not limited to, a display unit, an indicating device, a recording device, a computing device, and so forth. In an embodiment, the output device 106 may be associated with a graphical user interface, an interactive user interface, and the like.

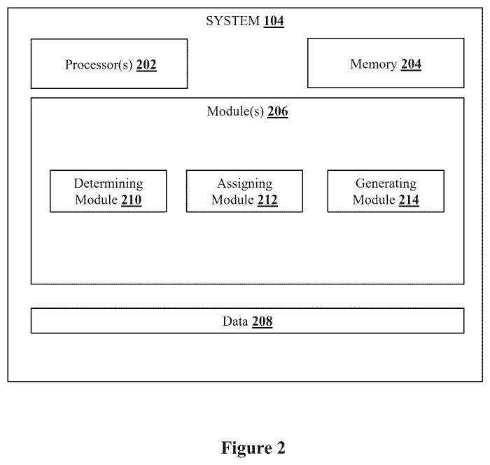

FIG. 2 illustrates a schematic block diagram of components of the system 104 for generating the knowledge graph 110, according to an embodiment of the present invention.

The system 104 may include, but is not limited to, at least one processor 202 (alternatively referred to as processor), memory 204, modules 206, and data 208. The modules 206 and the memory 204 may be communicably coupled to the processor 202.

The processor 202 can be a single processing unit or several units, all of which could include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is adapted to fetch and execute computer-readable instructions and data stored in the memory 204.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The modules 206, amongst other things, include routines, programs, objects, components, data structures, etc., which perform particular tasks or implement data types. The modules 206 may also be implemented as, signal processor(s), state machine(s), logic circuitries, and/or any other device or component that manipulates signals based on operational instructions.

Further, the modules 206 can be implemented in hardware, instructions executed by a processing unit, or by a combination thereof. The processing unit can comprise a computer, a processor, a state machine, a logic array, or any other suitable devices capable of processing instructions. The processing unit can be a general-purpose processor which executes instructions to cause the general-purpose processor to perform the required tasks or, the processing unit can be dedicated to performing the required functions. In another embodiment of the present disclosure, the modules 206 may be machine-readable instructions (software) which, when executed by a processor/processing unit, perform any of the described functionalities.

In an embodiment, the modules 206 may include a determining module 210, an assigning module 212, and a generating module 214. The determining module 210, the assigning module 212, and the generating module 214 may be in communication with each other. The data 208 serves, amongst other things, as a repository for storing data processed, received, and generated by one or more of the modules 206.

Referring to FIG. 1 and FIG. 2 the determining module 210 may be configured to determine a causal chain of events corresponding to the input data 102. In an example, the causal chain of events indicates a cause-and-effect relationship among one or more entities (alternatively referred to as entities) within the input data 102 based on a causal expression.

Further, the assigning module 212 may be configured to assign one or more attribute labels (alternatively referred to as attribute labels) to the entities within the input data 102 using a Natural Language Processing (NLP) technique. In an example, the attribute labels indicate at least one of a topic label, a sentiment label, and a temporal label.

Further, the generating module 214 may be configured to create a plurality of nodes (alternatively referred to as nodes) based on the causal chain of events and the assigned attribute labels. In an example, each of the nodes indicates a collection of the entities having the assigned attribute labels.

Furthermore, the generating module 214 may be configured to generate the knowledge graph 110 based on clustering the nodes. In an example, the knowledge graph 110 provides a visual depiction of the causal chain of events among the entities such that each of the nodes is interlinked through at least one directional edge representing the causal chain of events, thus, offering richer insights on the related factors. Furthermore, the users may have the capability (via user input 108) to provide/generate queries, prompting the retrieval or the generation of the knowledge graph 110 containing the attribute labels. Moreover, users may have the option to implement parameter filters, including but not limited to, timeline constraints, to construct or generate the knowledge graph 110. In one example, the queries provided by the users may often be informed by the user's domain expertise.

For the sake of brevity, the architecture, and standard operations of the memory 204 and the processor 202 are not discussed in detail. In one embodiment, the memory 204 may be configured to store the information, the input data 102 as required by the processor 202 to perform the methods described herein. A detailed description of the module 206 is provided in the further paragraphs.

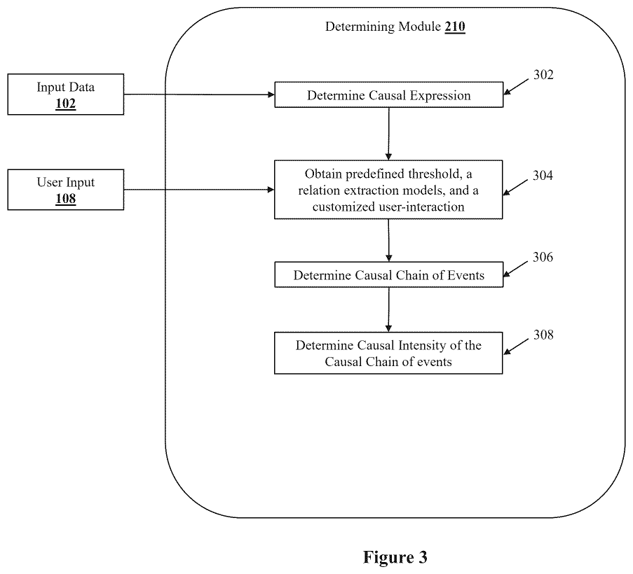

FIG. 3 illustrates an exemplary process flow of the determining module 210 of the system 104, according to an embodiment of the present invention.

At step 302, the determining module 210 may be configured to receive the input data 102. In an example, the input data 102 may be the forecast. In the example, the forecast may refer to predictions or projections about future events or trends. For example, forecasts could include predictions about stock market performance, weather patterns, or economic indicators.

In another example, the input data 102 may be related to news associated with a domain. These are news articles or reports that may be relevant to a specific field or subject area. For instance, if the system 104 is focused on finance, related news might include updates on financial markets, regulatory changes, or economic developments.

In another example, the input data 102 may be user-input text articles. This includes textual content provided by users (user input 108), which may consist of research articles, reports, opinions, or any other form of written content.

In another example, the input data 102 may be predictions pre-stored in the memory 204. These are predictions or forecasts that have been previously generated and stored within the system's 104 memory 204. These pre-stored predictions may serve as historical data points for analysis and comparison.

In another example, the input data 102 may be the set of keywords. The users may input (user input 108) specific terms or phrases as keywords to indicate areas of interest or topics that the users want to explore. The set of keywords helps narrow down the search and focus the analysis on relevant information.

Further in the example, when the input data 102 consists of the set of keywords provided by the user, the determining module 210 may be configured to search or retrieve for news articles or reports that are related to the provided keywords. In the example, the determining module 210 may be configured to retrieve from two sources, i.e., the memory 204 and/or an online network. For instance, the system 104 may have stored relevant news articles in the memory 204 from previous analyses or data collections. For another instance, if the relevant news articles are not found in the memory 204, the system 104 may search online networks such as news websites or databases to retrieve up-to-date articles related to the provided keywords.

Furthermore, the input data 102 may include entities. The entities may refer to elements, variables, or components present in the input data 102 being analyzed. The entities may represent various aspects, such as events, conditions, objects, or concepts, depending on the nature of the input data 102 and the specific context of analysis. For example, in textual data (input data 102), the entities may include individual words, phrases, sentences, or paragraphs that convey information relevant to the analysis. In the input data 102 containing information about financial transactions, entities might refer to specific transactions, accounts, dates, or transaction amounts. Thus, the entities may signify that the input data 102 may contain multiple elements or variables of interest, each potentially contributing to the analysis in different ways. Therefore, by analyzing and understanding the relationships between the entities within the input data 102, insights into the underlying structure, patterns, and dynamics within the input data 102 may be gained. In an advantageous aspect of the invention, identifying and analyzing the entities within the input data 102 may allow for the inference of causal relationships and the construction of the knowledge graph 110 that capture the interactions and dependencies among the entities. Therefore, the entities may serve as building blocks for understanding complex systems and phenomena and are essential for deriving meaningful insights from the input data 102.

Furthermore, in an advantageous aspect of the invention, the versatility of the system 104 in handling diverse types of input data 102, ranging from forecasts and news articles to user-generated content, keywords-based and pre-existing predictions, ensures that users have access to a broad spectrum of information relevant to their queries and analyses.

Further, in the step 302, the determining module 210 may be configured to determine the causal expression using the NLP technique. The causal expression may refer to a linguistic or formal representation of a cause-and-effect relationship between different entities or elements or variables within the input data 102. In NLP, the causal expression typically describes one event, action, or condition leading to another, implying the cause-and-effect relationship between entities of the input data 102. For example, in the sentence “Increased rainfall leads to higher crop yields,” the causal expression may be “Increased rainfall leads to higher crop yields.” Here, the causal expression may indicate that an increase in rainfall causes an increase in crop yields, establishing the cause-and-effect relationship between the two variables. In an example, the causal expression may take various forms, such as mathematical equations describing causal relationships between variables in a quantitative model, logical statements specifying causal dependencies between conditions or events, and natural language descriptions or narratives explaining the influence of certain events or conditions. In an advantageous aspect of the invention, the causal expression may play a crucial role in understanding and representing the causal relationships within the entities of the input data 102, thus, providing insights into the underlying mechanisms driving observed behaviour or outcomes.

Further, in the step 302, the determining module 210 may be configured to determine the causal expression from the input data 102 using the NLP techniques, specifically utilizing a Language Model (LLM) and a relation extraction model.

In an embodiment, the NLP technique may focus on enabling processors to understand, interpret, and generate human language. The NLP technique may involve various techniques and algorithms designed to process and analyze natural language data, such as text documents or speech. The LLM may be a statistical model trained on a large corpus of text data to predict the likelihood of a sequence of words occurring in a given context. The LLMs may be capable of capturing the syntactic and semantic relationships between words and phrases in a language (input data 102). In an example, the LLM may help in understanding the linguistic patterns and context within the input data 102. The Relation extraction model may be a specific task in NLP that involves identifying and extracting structured information about relationships between entities mentioned in the input data 102. The relation extraction model may be trained to recognize different types of relationships, such as causal relationships, within the input data 102. The relation extraction model typically employs machine learning (ML) algorithms to analyze linguistic features and patterns in the text (input data 102) and identify instances of specific relationships.

In an embodiment, the input data 102 containing textual information, such as news articles, research papers, or other documents may be used by the Language Model (LLM) to analyze and understand the language patterns and context within the input data 102. Consequently, the LLM may help in identifying relevant linguistic cues and expressions that may indicate causal relationships between the entities within the input data 102. Further, the relation extraction model may be applied to the text (input data 102) to specifically identify and extract instances of causal relationships among the entities. The relation extraction model may be trained to recognize linguistic patterns and features that typically indicate causality, such as trigger words, temporal indicators, and syntactic structures. Consequently, the system 104 may combine the capabilities of the Language Model (LLM) and the relation extraction model, to effectively determine the causal expression from the input data 102. Thus, the determination of the causal expression involves analyzing the linguistic content of the text (input data 102), identifying instances of causality, and structuring this information into a causal chain of events. Thus, the determined causal expression may provide valuable insights into the underlying causal relationships present in the input data 102, enabling further analysis and understanding of complex systems and phenomena.

At step 304, the determining module 210 may be configured to obtain a predefined threshold, the relation extraction models, and a customized user interaction. In an example, the predefined threshold, the relation extraction models, and the customized user interaction may be certain factors influencing the determination of the causal chain of events in the subsequent steps.

In an example, the predefined threshold may be set to determine the strength or significance of the cause-and-effect (causal) relationship. For example, only the cause-and-effect relationship(s) above a certain statistical confidence level (the predefined threshold) may be considered. Thus, the predefined threshold may ensure that only significant causal relationships are considered by the system 104. Thus, by establishing a minimum level of confidence or relevance, the system 104 may filter out noise or spurious correlations, focusing on relationships that are statistically significant or contextually relevant.

In an example, the relation extraction models may automatically identify and extract structured information about relationships between entities mentioned in the input data 102. Consequently, the relation extraction models may leverage machine learning algorithms to analyze linguistic patterns and features, enabling the system 104 to automatically detect instances of the cause-and-effect relationship without manual intervention. Thus, in an advantageous aspect of the invention, utilizing the relation extraction models may enhance the efficiency and scalability of the causal chain determination process. Instead of relying solely on manual analysis, which can be time-consuming and impractical for large input data 102, the relation extraction models may enable the system 104 to analyze vast amounts of input data 102 rapidly and accurately, thereby accelerating the knowledge graph 110 generation process.

In an example, the customized user interaction may correspond to the users interacting with the system 104 to adjust or refine the knowledge graph 110 (post-generation) based on preferences or requirements. The customized user interaction may involve providing feedback, adjusting parameters, or specifying additional criteria for determining the cause-and-effect (causal) relationship. In the example, the customized user interaction may allow the users to adjust or refine the determination of causal relationships based on their specific needs, preferences, or domain expertise. The users may provide feedback, adjust parameters, or specify additional criteria to tailor the analysis to their requirements, ensuring that the determined causal chain of events reflects the user's understanding of the input data 102 and its context.

At step 306, the determining module 210 may be configured to determine the causal chain of events indicating the cause-and-effect relationship among the entities within the input data 102. In an example, the determining module 210 may be configured to analyze the causal expressions within the input data 102, to determine the causal chain of events. The causal chain of events may represent the sequence of the cause-and-effect relationships among the entities, illustrating one event or condition leading to another. The causal chain of events outlines the interconnected sequence of the cause-and-effect relationships among the entities within the input data 102. Thus, demonstrating the occurrence of one event or condition influencing or leading to the occurrence of subsequent events or conditions, thereby establishing the causal relationship among the entities.

At step 308, the determining module 210 may be configured to determine the causal intensity. In an example, the causal intensity may refer to the strength or degree of influence that the entities have on one another within the cause-and-effect relationship. Thus, the causal intensity may be a measure of the magnitude or extent of the causal relationship between the entities within the knowledge graph 110. The determination of the causal intensity may rely on several factors, including correlation value, latency value, and directness value of a causal link.

In an example, the correlation value measures the degree of statistical association between the cause-and-effect entities. The correlation value quantifies how closely related changes in one entity are to changes in another. In the example, a high correlation value may indicate a strong relationship between the entities, suggesting that changes in one entity are likely to result in corresponding changes in the other. Conversely, a low correlation value may suggest a weaker relationship.

In an example, the latency value may refer to the time delay between the occurrence of the cause and the subsequent effect. The latency value may measure an effect entity responding to changes in a cause entity. In the example, a shorter latency value may indicate a more immediate cause-and-effect relationship, where changes in the cause entity may lead to rapid changes in the effect entity. Alternatively, a longer latency value may suggest a delayed response, with changes in the cause entity taking more time to manifest in the effect entity.

In an example, the directness value assesses the degree of intermediaries or intermediate entities involved in the cause-and-effect relationship between the entities (cause and effect). A direct causal link implies a straightforward connection between the cause and effect, with no intermediate steps or entities influencing the relationship. In contrast, an indirect causal link involves one or more intermediate entities that mediate or modulate the relationship between the cause-and-effect entities. In the example, a higher directness value may indicate a more direct influence between the entities, while a lower directness value suggests a more complex or indirect relationship.

In an advantageous aspect of the invention, the determination of the causal intensity (higher causal intensity) signifies a stronger and more immediate influence, or while the causal intensity (lower causal intensity) indicates a weaker or more indirect influence. Thus, the determination of the causal intensity helps prioritize and contextualize the cause-and-effect (causal) relationship within the knowledge graph 110, enabling a more nuanced understanding of the dynamics and interactions between entities of the input data 102.

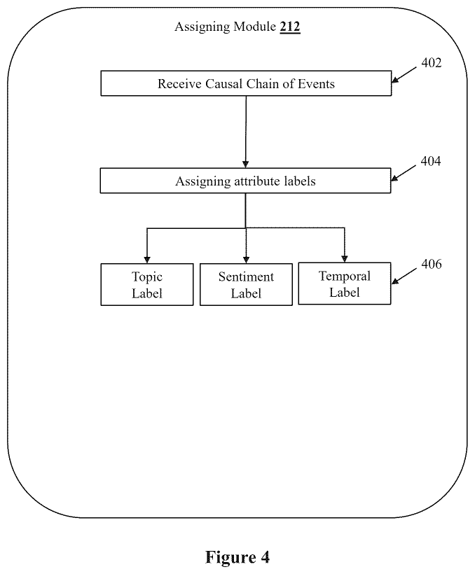

FIG. 4 illustrates an exemplary process flow of the assigning module 212 of the system 104, according to an embodiment of the present invention.

At step 402, the assigning module 212 may be configured to receive the causal chain of events.

At step 404, the assigning module 212 may be configured to assign attribute labels to the entities within the input data 102 using the NLP technique.

In an embodiment, the input data 102 may be preprocessed to remove noise, such as punctuation, special characters, and stop words. Additionally, the text in the input data 102 may be tokenized into words or phrases. Further, each word or phrase in the text is tagged with its part of speech (noun, verb, adjective, etc.) to identify the grammatical structure of the text. NER is used to identify and classify named entities in the text, such as persons, organizations, locations, dates, and other entities of interest. This step helps identify the entities that may be relevant for assigning attribute labels such as the topic label, the sentiment label, and the temporal label.

At step 406, the assigning module 212 may be configured to assign at least one of the attribute labels—the topic label, the sentiment label, and the temporal label to the entities.

In an example, the topic label may include identifying the main subject or theme addressed in the text (input data 102). The NLP techniques may be used to analyze the content and determine the primary topic or topics discussed in the input data 102. For example, in a news article, the topic label might indicate whether the article is about politics, sports, technology, etc. The topic modelling techniques, such as Latent Dirichlet Allocation (LDA) or Non-negative Matrix Factorization (NMF), can be applied to identify the main topics or themes present in the text (input data 102). Thus, each document or sentence may be assigned one or more topic labels based on the distribution of words.

In an example, the sentiment label may refer to determining the emotional tone or sentiment expressed in the text (input data 102). The NLP techniques may be employed to analyze the language used and classify the sentiment as positive, negative, or neutral such that the sentiment label may provide insights into the attitudes, opinions, or feelings conveyed in the text (input data 102). For instance, the sentiment label may indicate whether a product review is positive or negative. The sentiment analysis techniques may be applied to determine the emotional tone or sentiment expressed in the text (input data 102). This can be done using rule-based approaches, machine learning models, or lexicon-based methods to classify the sentiment as positive, negative, or neutral.

In an example, the temporal label may include identifying time-related information mentioned in the text (input data 102), such as dates, time-periods, or chronological sequences. The NLP techniques may be utilised to extract temporal references and assign labels accordingly. This helps in understanding the temporal context of events described in the text (input data 102). For example, the temporal labelling may indicate when specific events occurred or the order in which they occurred. The temporal labelling techniques may be applied by identifying temporal expressions in the text (input data 102) and normalized to standard formats for instance, dates, times, and durations. The temporal labelling techniques may involve parsing natural language expressions and mapping them to specific points or intervals in time.

Consequently, the outputs (topic labels, sentiment labels, temporal labels, etc.) may be integrated and assigned to the corresponding entities in the text (input data 102). For instance, assigning may involve associating topic labels with relevant keywords or named entities, sentiment labels with specific phrases or sentences, and temporal labels with temporal expressions.

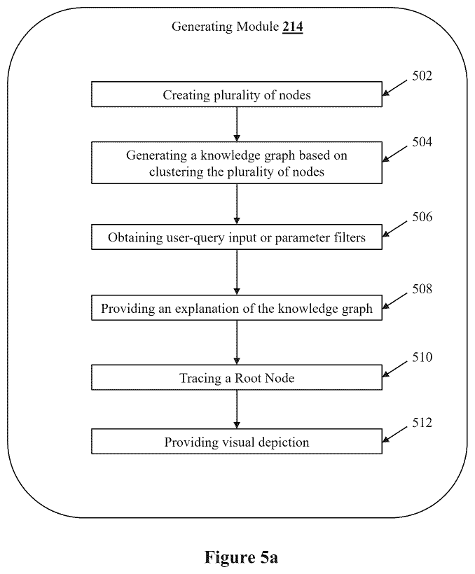

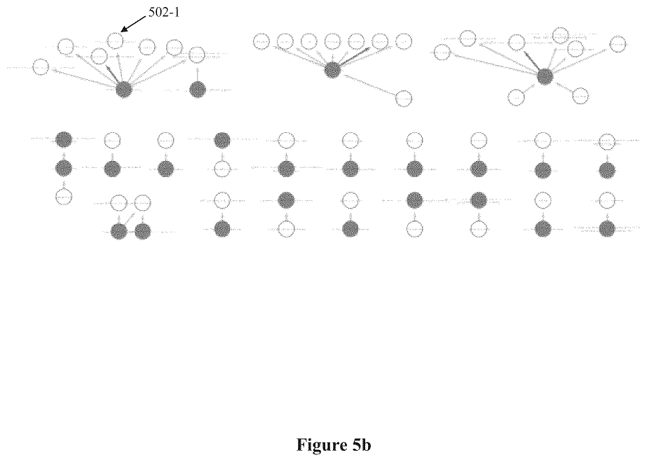

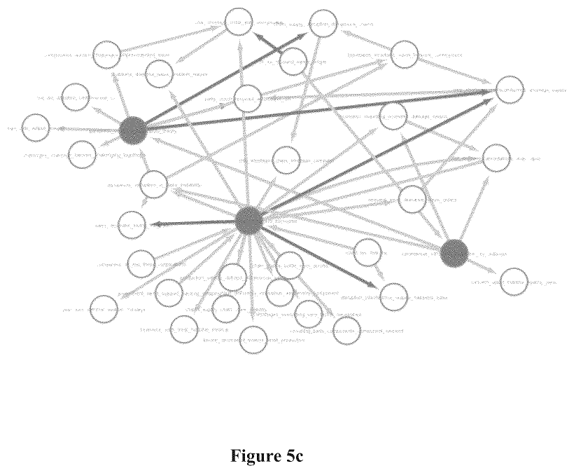

FIG. 5a illustrates an exemplary process flow of the generating module 214 of the system 104, according to an embodiment of the present invention.

At step 502, the generating module 214 may be configured to create the nodes based on the causal chain of events and the assigned attribute labels including structuring the input data 102 into a graph-like representation where each node may represent a collection of the entities with similar attribute labels.

In an example, the nodes may represent individual entities or elements within the input data 102, and the nodes may be interconnected by edges to depict relationships between them. Thus, the nodes may serve as the fundamental building blocks of the representation of the knowledge graph 110.

In an example, creating the nodes may include grouping the entities together based on both the causal chain of events and the assigned attribute labels. Each node may represent a collection of the entities that share similar attributes and are interconnected by the causal relationships identified in the input data 102.

Further, each of the node in the knowledge graph 110 may indicate a specific subset of the entities that exhibit similar attributes or characteristics. For example, a node may represent a group of entities related to a particular topic, sentiment, or time-period (temporal) within the input data 102.

Furthermore, the nodes may be interconnected based on the cause-and-effect (causal) relationship identified in the input data 102. This interconnectedness reflects the causal dependencies between different subsets of entities and illustrates changes in one subset influencing other subsets.

Consequently, creating the nodes based on the causal chain of events and assigned attribute labels may include organizing the input data 102 into a structured graph representation. In an advantageous aspect of the invention, the structured graph representation may facilitate the visualization and analysis of the input data 102, enabling insights into the relationships and dependencies among the entities with similar attribute labels.

At step 504, the generating module 214 may be configured to generate the knowledge graph 110 by clustering the nodes. In an example, the clustering may include grouping the nodes based on similarities in their attribute labels or characteristics. The nodes that share common attribute labels may be clustered together to form distinct groups or clusters. This clustering process helps organize the entities (input data) and reveals patterns or relationships among the entities with similar attribute labels. The clustering of the nodes is depicted and explained with FIG. 5c in the forthcoming paragraphs.

In an embodiment, the relationships between the nodes are illustrated using the directional edges in the knowledge graph 110. In an example, the directional edges may be used to depict the causal chain of events among the entities. The directional edge connects two nodes, indicating the direction of influence from the cause to the effect. For example, if Node ‘A’ represents the cause and Node ‘B’ represents the effect, a directional edge from Node ‘A’ to Node ‘B’ indicates that changes in Node ‘A’ cause changes in Node ‘B’.

The knowledge graph 110 may provide a visual depiction of the causal chain of events among the entities within the input data 102. The nodes may be represented as graphical elements and the directional edges may connect nodes to illustrate the causal relationships between them. In a non-limiting example, the layout and visualization of the knowledge graph 110 may vary depending on the clustering algorithm and visualization techniques used.

Consequently, within the knowledge graph 110, each of the nodes may be interconnected with the other nodes through the directional edges, representing the causal relationships identified in the input data 102. This interconnectedness illustrates the propagation of changes in one entity through the system 104, influencing other entities in the causal chain of events.

In an advantageous aspect of the invention, the generated knowledge graph 110 may enable the users to visually explore and analyze the causal relationships among the entities within the input data 102. Thus, by examining the clusters and the directional edges, users may gain insights into the underlying causal dynamics and dependencies, facilitating a deeper understanding of the system or phenomena under study.

In an embodiment, clustering the nodes is based on a semantic similarity to identify higher-level causal structures in the generated knowledge graph 110. In an example, semantic similarity may be a measure of similarity between two nodes in terms of their meaning or semantic content. The semantically similar nodes are likely to represent the entities or concepts that share common attributes, properties, or relationships. Thus, by clustering the nodes based on semantic similarity, higher-level causal structures may be identified within the generated knowledge graph 110. These higher-level structures represent broader patterns or themes in the causal relationships among the entities. In an aspect of the present disclosure, the higher-level structures may also enhance the information content and brevity of the output.

In an embodiment, clustering the nodes in the generated knowledge graph 110 is based on extracting temporal information indicative of time or temporal order from the input data 102 and assigning the temporal label to each of the nodes based on the extracted temporal information such that a chronological relationship is created in the causal chain of events providing a temporal context within the knowledge graph 110. Thus, by assigning temporal labels to the clusters of the nodes, a chronological relationship is established within the knowledge graph 110. The nodes within the same cluster share a common temporal context, indicating that they are associated with events or entities occurring during the same time-period. This creates a temporal context within the knowledge graph 110, allowing users to understand the sequence of events or the temporal order of entities within the input data 102.

The knowledge graph 110 with clustered nodes and assigned temporal labels provides a visual representation of the temporal relationships among entities within the input data 102. The users may explore the knowledge graph 110 to identify patterns, trends, and dependencies over time, gaining insights into how events unfold and evolve chronologically.

In an embodiment, clustering the nodes within the knowledge graph 110 may provide several advantages, enabling various functionalities and enhancing the utility of the knowledge graph 110. Clustering the nodes may lead to an increase in the density of the generated knowledge graph 110. Thus, by clustering the nodes with similar attributes or characteristics together, clusters form dense regions within the knowledge graph 110. The density increase enhances the overall richness and complexity of the knowledge graph 110, thus, providing more detailed insights into the relationships and dependencies among entities.

Further, clustering allows users to manually label cause-and-effect relationships into explainable groups within the knowledge graph 110. Thus, by organizing the nodes into clusters based on common attributes or characteristics, users may identify groups of the entities that are causally related or exhibit similar behaviour. The manual labelling of the clusters provides a way to interpret and explain the underlying patterns and relationships present in the input data 102, facilitating understanding and interpretation.

Furthermore, clustering may enable the capture of domain expertise within the knowledge graph 110 through customization. The users may tailor the clustering process to align with domain-specific knowledge and expertise, ensuring that the resulting clusters accurately reflect the underlying structure and dynamics of the input data 102 within the context of the domain. This customization allows users to incorporate domain-specific insights, preferences, or constraints into the analysis, enhancing the relevance and utility of the knowledge graph 110 for domain-specific applications.

At step 506, the generating module 214 may be configured to allow the users to search the knowledge graph 110 based on the attribute labels associated with each of the nodes. Each node in the knowledge graph 110 is assigned attribute labels, such as topic, sentiment, or temporal labels, as explained in the above paragraphs. The users may input queries (user-query input) specifying desired attribute labels, and the system 104 may retrieve relevant nodes matching those attribute labels. For example, the user may search for nodes related to a specific topic, sentiment, or time-period, and the system 104 returns the nodes matching the specified criteria.

At step 508, the generating module 214 may be configured to provide an explanation of the knowledge graph 110 based on the causal chain of events and the user-query input. The system 104 may provide explanations or insights into the causal relationships and connections among the identified nodes, helping the users understand the underlying patterns and dependencies. For example, the system 104 may highlight causal chain of events leading to specific events or entities of interest, providing context and explanations for their relationships within the knowledge graph 110.

At step 510, the generating module 214 may be configured to trace a root node among the nodes in the generated knowledge graph 110 based on the causal chain of events and the user-query input such that a reverse traversal trajectory corresponding to the directional edge is created in the generated knowledge graph 110. The system 104 may identify the starting point or root node of the causal chain of events relevant to the user's query. The system 104 may then trace a reverse traversal trajectory along the directional edges of the knowledge graph 110, moving from effect nodes back to the root node. Thus, this reverse traversal trajectory provides the users with a clear path to understanding the cause-and-effect (causal) relationships leading to the identified events or the entities. For example, if the user queries about a specific event, the system 104 may trace back the causal chain of events leading to that event, allowing the users to understand the underlying causes and factors contributing to it.

At step 512, the generating module 214 may be configured to visualize the causal chain of events by creating a graphical representation of the knowledge graph 110 on the output device 106.

FIG. 5b illustrates an exemplary use-case depicting the nodes 502-1 created by the generating module 214, based on the causal chain of events, according to an embodiment of the present invention. In an example, the nodes 502-1 as depicted represent a state before performing the clustering.

FIG. 5c illustrates an exemplary use-case depicting the clustering of the nodes 502-1 to generate the knowledge graph by the generating module 214, based on the causal chain of events, according to an embodiment of the present invention.

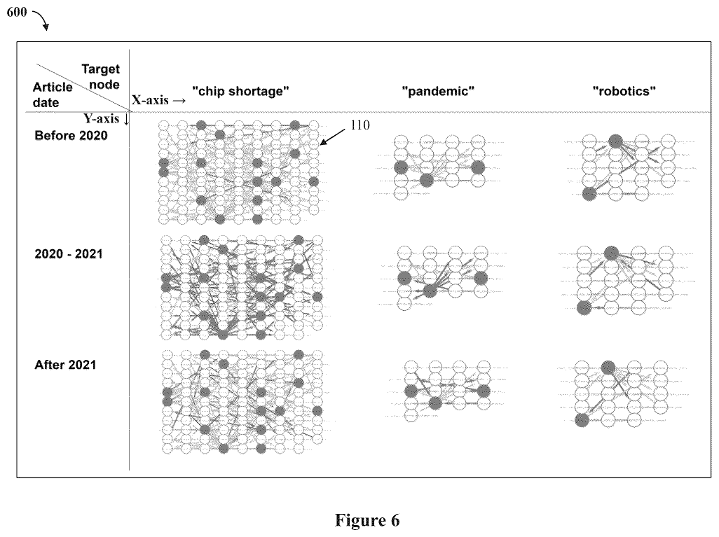

FIG. 6 illustrates an exemplary use-case depicting the knowledge graph using the system, according to an embodiment of the present invention.

As depicted, the knowledge graph 110 showcases the nodes emphasized according to the topic labels (displayed on the x-axis). Additionally, the knowledge graph 110 may exhibit tracing of the root node amidst the numerous nodes based on the temporal label (represented on the y-axis).

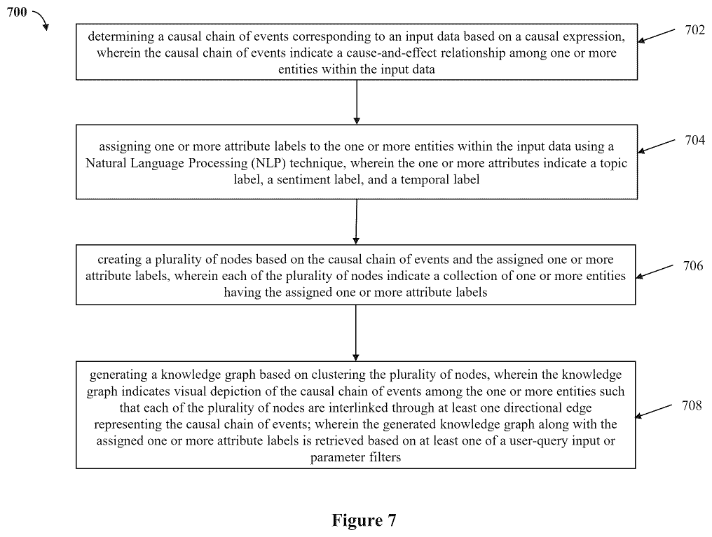

FIG. 7 illustrates a flowchart depicting a method 700 for generating the knowledge graphs 110, according to another embodiment of the present disclosure. The method 700 may be performed by the system 104, in particular, the processor 202 of the system 104. For the sake of brevity, steps explained in FIG. 3-FIG. 5 are not repeated in the following FIG. 7.

The method 700 may include receiving the input data 102.

At step 702, the method 700 may include determining the causal chain of events corresponding to an input data based on the causal expression, wherein the causal chain of events indicates a cause-and-effect relationship among one or more entities within the input data.

At step 704, the method 700 may include assigning one or more attribute labels to the one or more entities within the input data using the NLP technique, wherein the one or more attributes indicate the topic label, the sentiment label, and the temporal label.

At step 706, the method 700 may include creating the nodes based on the causal chain of events and the assigned attribute labels, wherein each of the nodes indicates the collection of the entities having the assigned one or more attribute labels.

At step 708, the method 700 may include generating the knowledge graph 110 based on clustering the nodes, wherein the knowledge graph 110 indicates the visual depiction of the causal chain of events among the entities such that each of the nodes is interlinked through at least one directional edge representing the causal chain of events. The generated knowledge graph 110 along with the assigned attribute labels is retrieved based on at least one of the user-query input or parameter filters.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

We claim:

1. A method for generating a knowledge graph, the method comprising:
determining a causal chain of events corresponding to an input data based on a causal expression, wherein the causal chain of events indicates a cause-and-effect relationship among one or more entities within the input data;
assigning one or more attribute labels to the one or more entities within the input data using a Natural Language Processing (NLP) technique, wherein the one or more attributes indicate a topic label, a sentiment label, and a temporal label;
creating a plurality of nodes based on the causal chain of events and the assigned one or more attribute labels, wherein each of the plurality of nodes indicates a collection of one or more entities having the assigned one or more attribute labels; and
generating a knowledge graph based on clustering the plurality of nodes, wherein the knowledge graph indicates a visual depiction of the causal chain of events among the one or more entities such that each of the plurality of nodes is interlinked through at least one directional edge representing the causal chain of events;
wherein the generated knowledge graph along with the assigned one or more attribute labels is retrieved based on at least one of a user-query input or parameter filters.

2. The method as claimed in claim 1, wherein the user-query is based on a domain expertise of a user and the parameter filters include a timeline.

3. The method as claimed in claim 1, wherein the input data includes one of a forecast, related news associated with a domain, user-input text articles, predictions pre-stored in a memory, and a set of keywords.

4. The method as claimed in claim 3, wherein when the input data is the set of keywords, the method comprises: retrieving the related news articles from one of the memory and online networks.

5. The method as claimed in claim 1, wherein the causal expression is inferred using Natural Language Processing (NLP) techniques including Language Model (LLM) and a relation extraction model for determining the causal chain of events in the input data.

6. The method as claimed in claim 1, wherein determining the causal chain of events indicating the cause-and-effect relationship among one or more entities based on at least one of a predefined threshold, a relation extraction model, and a customized user-interaction for adjusting the knowledge graph.

7. The method as claimed in claim 6, further comprising: determining a causal intensity for the cause-and-effect relationship of each of the one or more entities based on a correlation value, a latency value, and a directness value of a causal link, wherein the causal intensity indicates a degree of influence that each of the one or more entities has on another within the knowledge graph.

8. The method as claimed in claim 1, comprising:
enabling a user search of the generated knowledge graph based on one or more attribute labels associated with each of the plurality of nodes upon receiving the user-query input;
providing an explanation of the generated knowledge graph based on the causal chain of events and the user-query input; and
tracing a root node among the plurality of nodes in the generated knowledge graph based on the causal chain of events and the user-query input such that a reverse traversal trajectory corresponding to the at least one directional edge is created in the generated knowledge graph.

9. The method as claimed in claim 1, wherein clustering the plurality of nodes is based on a semantic similarity to identify higher-level causal structures in the generated knowledge graph.

10. The method as claimed in claim 1, wherein:
clustering the plurality of nodes in the generated knowledge graph is based on extracting temporal information indicative of time or temporal order from the input data; and
assigning the temporal label to each of the plurality of nodes based on the extracted temporal information such that a chronological relationship is created in the causal chain of events providing a temporal context within the knowledge graph.

11. The method as claimed in claim 9, wherein: clustering the plurality of nodes enables one of, density increase of the generated knowledge graph, the user to manually label the cause-and-effect relationship into explainable groups, and capture domain expertise with customization.

12. A system for generating a knowledge graph, the system comprising:
a memory;
at least one processor in communication with the memory, and the at least one processor is configured to:
determine a causal chain of events corresponding to an input data based on a causal expression, wherein the causal chain of events indicates a cause-and-effect relationship among one or more entities within the input data;
assign one or more attribute labels to the one or more entities within the input data using a Natural Language Processing (NLP) technique, wherein the one or more attributes indicate a topic label, a sentiment label, and a temporal label;
create a plurality of nodes based on the causal chain of events and the assigned one or more attribute labels, wherein each of the plurality of nodes indicates a collection of one or more entities having the assigned one or more attribute labels; and
generate a knowledge graph based on clustering the plurality of nodes, wherein the knowledge graph indicates a visual depiction of the causal chain of events among the one or more entities such that each of the plurality of nodes is interlinked through at least one directional edge representing the causal chain of events;
wherein the generated knowledge graph along with the assigned one or more attribute labels is retrieved based on at least one of a user-query input or parameter filters.

13. The system as claimed in claim 12, wherein the user-query is based on domain expertise of a user and the parameter filters include a timeline.

14. The system as claimed in claim 12, wherein the input data includes one of a forecast, related news associated with a domain, user-input text articles, predictions pre-stored in a memory, and a set of keywords.

15. The system as claimed in claim 14, wherein when the input data is the set of keywords, the at least one processor is configured to: retrieve the related news articles from one of the memory and online networks.

16. The system as claimed in claim 12, wherein the causal expression is inferred using Natural Language Processing (NLP) techniques including Language Model (LLM) and a relation extraction model for determining the causal chain of events in the input data.

17. The system as claimed in claim 12, wherein the at least one processor is configured to determine the causal chain of events indicating the cause-and-effect relationship among one or more entities based on at least one of a predefined threshold, a relation extraction models, and a customized user-interaction for adjusting the knowledge graph.

18. The system as claimed in claim 17, the at least one processor is configured to:
determine a causal intensity for the cause-and-effect relationship of each of the one or more entities based on a correlation value, a latency value, and a directness value of a causal link, wherein the causal intensity indicates a degree of influence that each of the one or more entities has on another within the knowledge graph.

19. The system as claimed in claim 12, the at least one processor configured to:
enable a user search of the generated knowledge graph based on one or more attribute labels associated with each of the plurality of nodes upon receiving the user-query input;
provide an explanation of the generated knowledge graph based on the causal chain of events and the user-query input; and
trace a root node among the plurality of nodes in the generated knowledge graph based on the causal chain of events and the user-query input such that a reverse traversal trajectory corresponding to the at least one directional edge is created in the generated knowledge graph.

20. The system as claimed in claim 12, wherein clustering the plurality of nodes is based on a semantic similarity to identify higher-level causal structures in the generated knowledge graph.

21. The system as claimed in claim 12, the at least one processor configured to:
cluster the plurality of nodes in the generated knowledge graph is based on extracting temporal information indicative of time or temporal order from the input data; and
assign the temporal label to each of the plurality of nodes based on the extracted temporal information such that a chronological relationship is created in the causal chain of events providing a temporal context within the knowledge graph.

22. The system as claimed in claim 20, wherein: clustering the plurality of nodes enables one of, density increase of the generated knowledge graph, the user to manually label the cause-and-effect relationship into explainable groups, and capture domain expertise with customization.
